(19) United States
(12) Patent Application Publication
(10) Pub. No.: US 2022/0315421 A1
(43) Pub. Date: Oct. 6, 2022

(54) PROCESS AND APPARATUS FOR CRACKING HYDROCARBON GASES

(71) Applicant: Synhelion AG, Lugano (CH)

(72) Inventors: Gianluca AMBROSETTI, Gintilino (CH); Philipp GOOD, Zurich (CH); Lukas GEISSBÜHLER, Bern (CH)

(21) Appl. No.: 17/602,200

(22) PCT Filed: Apr. 10, 2020
(86) PCT No.: PCT/CH2020/050003

§ 371 Date: Jun. 9, 2022

(30) Foreign Application Priority Data
Apr. 12, 2019 (CH) 00506/19
Nov. 7, 2019 (CH) 01407/19

(51) Int. Cl. C01B 3/24; B01J 19/00; B01J 19/12; F24S 20/20; F24S 70/60; C01B 3/04

(52) U.S. Cl. CPC C01B 3/24; B01J 19/0013; B01J 19/123; F24S 20/20; F24S 70/60; C01B 3/042; C01B 2203/0266; C01B 2203/0866; C01B 2203/1241; C01B 2203/0255; B01J 2219/00076; B01J 2219/00087

(57) ABSTRACT

Process for cracking hydrocarbon gases, wherein the hydrocarbon gas is passed through a flow channel of an absorptive receiver reactor (1, 30, 40), characterized in that cracking takes place during the passing through the receiver reactor (1, 30, 40), wherein in a first region (21) of the flow channel (2) the hydrocarbon gas is heated to its cracking temperature, in an adjoining second, downstream flow region (22) is heated to beyond its cracking temperature and in a third, further downstream region (23) of the flow channel is heated yet further and is brought therein into physical contact, over the cross-section of said region, with a reaction accelerator, after which the stream of products downstream of the reaction accelerator is discharged from the receiver reactor (1, 30, 40), and wherein the heating of the hydrocarbon gas to above its cracking temperature is achieved by absorption of blackbody radiation (20) which is given off by the reaction accelerator heated by solar radiation (7) incident thereupon to the hydrocarbon gas flowing towards it, in such a way that the hydrocarbon gas in the flow channel (2) and extending up to the reaction accelerator forms disc-shaped, consecutive temperature zones (60 to 67) of ever-increasing temperature extending transversely to the flow channel (2).

The present invention relates to a process for cracking hydrocarbon gases, in particular methane, according to the preamble of Claim 1, and receiver reactors for performing this process according to the preamble of Claims 18, 21 and 23, as well as a use of a solid-state heat accumulator according to Claim 34.

Cracking of hydrocarbon gases such as methane, ethane, propane or even butane is generally carried out on an industrial scale, and particularly the cracking of methane is considered to be a potential technology of the future, since the reaction CH₄->C+2H₂ takes place in the absence of oxygen, and consequently does not release any CO₂ emissions. The hydrogen generated functions as the energy carrier, while the carbon is used industrially to manufacture products such as carbon black, graphite, diamonds, carbon fibres, conductive plastics or tyres.

Until now, there have been no known industrially applicable, cost-effective processes for cracking methane using solar energy. A difficulty in this regard is the high temperatures required, in the range from about 500° C. to about 1200° C. at ambient pressure. At 500° C. (referred to hereinafter as the cracking temperature), just under 50% of the methane is dissociated in the steady state condition, at 1200° C., dissociation is complete, although the steady state condition is only reached after a long (theoretically infinite) time. Under higher operating pressure, higher temperatures are needed to achieve the same steady state condition, i.e. in order to convert a comparable percentage of the methane. Overall, the reaction is energy-intensive, slow, and difficult to manage; furthermore, the carbon is released in the form of free nanoparticles, that is to say soot.

WO 2018/205043 discloses a solar receiver in which a fluid that carries heat so the heat can be used in a downstream industrial process passes through an absorption chamber of the receiver and can be heated absorptively to the desired process heat therein by the black body radiation of the absorber in said receiver, i.e. by infrared radiation, wherein besides CO₂, steam, SO₂, SO₃, NO, NO₂ and HCl, methane in its property as an infrared-absorptive gas is also considered to be a suitable heat carrier for transporting heat to a consumer.

In U.S. Pat. No. 7,140,181, it is suggested to use solar reactors for endothermic reactions such as cracking of gases, wherein the production of CO as a syngas component from CO₂ with the aid of a specially designed receiver reactor is described. In this receiver reactor, a ceramic rod is provided in a tunnel for generating the required high temperatures. Another variant of a receiver reactor is described generally as an ellipsoidal “holraum reactor”, in which, in order to achieve high thermal efficiency a gas to be dissociated is to be preheated by absorption and then heated up to the dissociation temperature by convection over the entire large area of the reactor walls made available by the ellipsoid.

Accordingly, it is the object of the present invention to provide a solar process for the cracking of methane and a receiver reactor for the cracking of methane.

This object is solved by the process having the characterizing features of Claim 1 and by receiver reactors having the characterizing features of Claims 18, 21 and 23, and by the use of a stratified solid-state heat accumulator according to Claim 34.

Since the hydrocarbon gas or methane forms disc-shaped temperature zones aligned transversely to the flow path, and consequently a predetermined, defined temperature stratification having the same temperature level in the respective strata in the receiver reactor, the methane undergoes constant warming in the direction of the reaction accelerator and at the same time cold zones or overheated zones which might adversely affect the degree of dissociation cannot form or persist, with the result that the entire methane stream is heated incrementally to the desired reaction temperature. The process of bringing the methane into contact with a physical reaction accelerator has the effect of increasing the reaction speed to such a degree that a largely complete reaction takes place in the receiver reactor through which the methane passes. As the methane is raised to higher than its cracking temperature by absorption and is discharged at a higher level still, the result is a particularly efficient thermochemical process, wherein the cracking reaction may then be initiated comparatively abruptly in the reaction accelerator until an equilibrium temperature for complete dissociation (and higher), wherein all these advantages are gained in a receiver reactor of simple design and with low maintenance requirement.

Since the receiver reactor can be operated alternatingly with a reducible gas, syngas is produced even when the receiver reactor undergoes maintenance with regard to carbon deposits, the syngas then being reusable on an industrial scale for the synthetic production of fuels.

Since the receiver reactor has an apparatus for generating particles in the absorber region, a permanently installed absorber may be replaced by a cloud of particles, with the advantage that carbon deposits form on the particles, carbon and hydrogen are thus discharged directly from the receiver reactor with the flow of the products via the particles, so that no maintenance regarding carbon deposits is required in this respect, and overall the need for maintenance is reduced correspondingly.

Since the receiver reactor is equipped with replaceable absorber elements, an element whose functionality is impaired due to carbon deposits may be swapped out and cleaned separately or replaced even during operation, while the operation is in progress, for example, or with only a brief pause in operation.

The use of a stratified solid state heat accumulator for cracking hydrocarbon gases gives rise to another simple, inexpensive option for enabling cracking to continue overnight, wherein the heat needed therefor is introduced into the heat accumulator that is used as the heat accumulator reactor, preferably by a receiver reactor, during daytime operation.

Further preferred variants have the features of the dependent claims.

In the following text, the invention will be described in rather more detail with reference to the figures.

In the drawing:

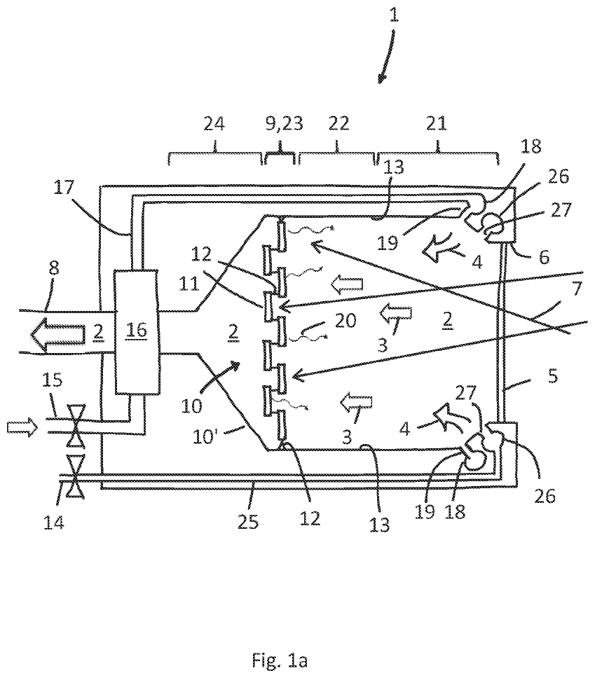

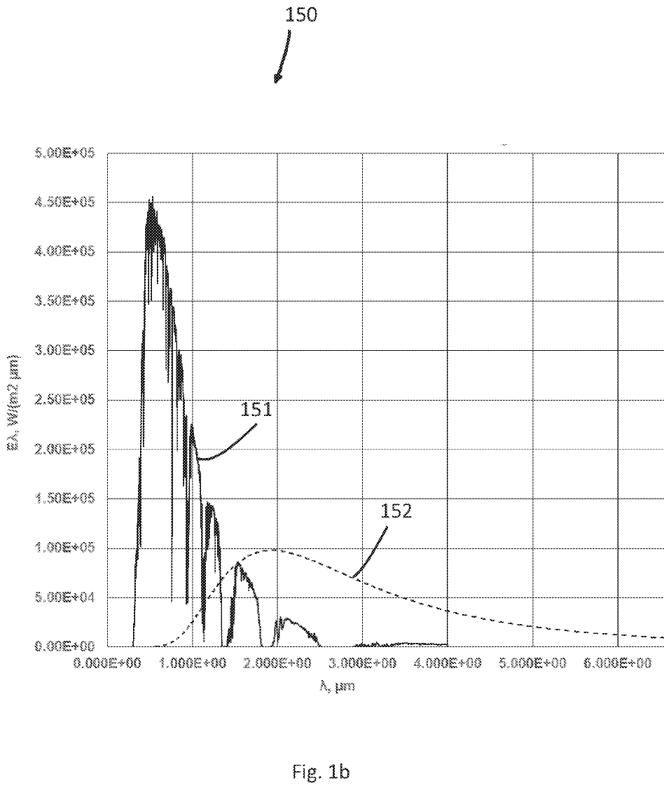

FIG. 1a shows a schematic view of a longitudinal section through a receiver reactor designed according to the invention according to a first exemplary embodiment,

FIG. 1b shows the radiation intensity of solar radiation compared with the intensity of the radiation from a black body at 1500 K,

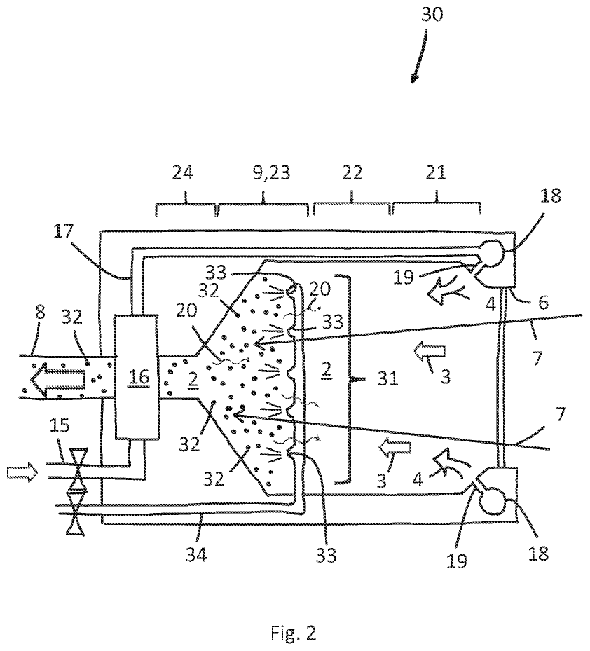

FIG. 2 shows a schematic view of a longitudinal section through a receiver reactor designed according to the invention according to a second exemplary embodiment,

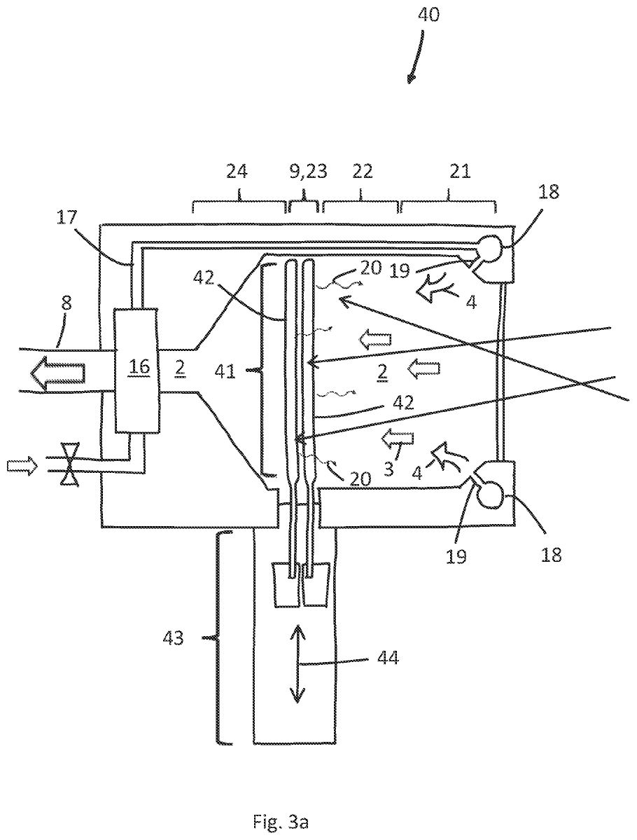

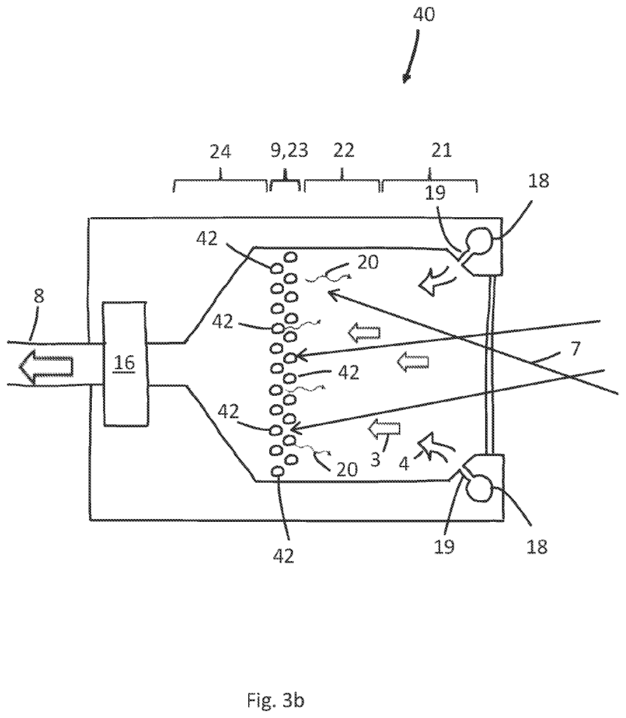

FIG. 3a shows a schematic view of a longitudinal section through a receiver reactor designed according to the invention according to a third exemplary embodiment,

FIG. 3b shows a schematic view of a longitudinal section through the receiver reactor of FIG. 3a, wherein the cross section is aligned with an offset of 90 degrees,

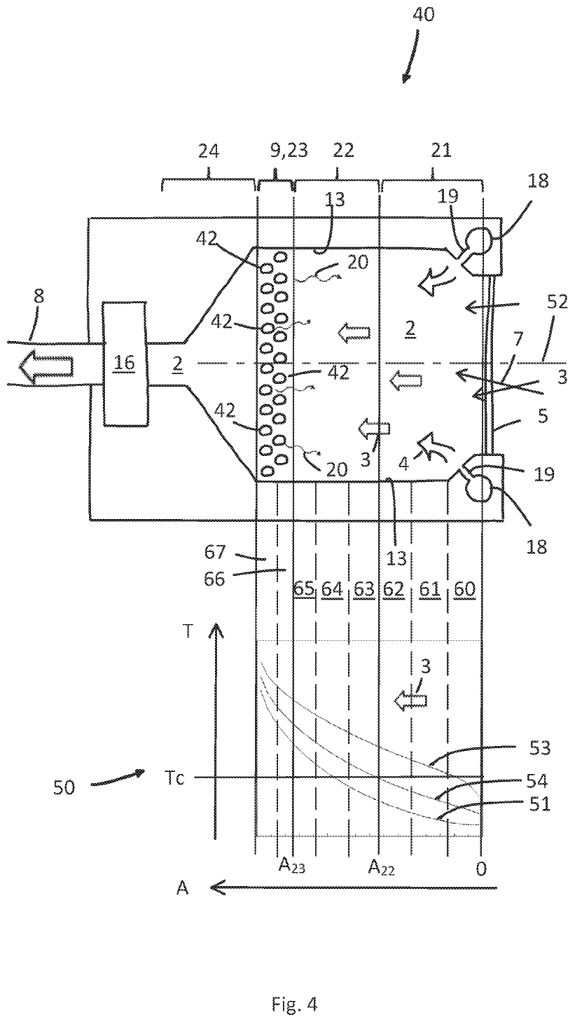

FIG. 4 shows a schematic view of the longitudinal section of FIG. 3b together with a chart of the temperature distribution during operation of the receiver reactor,

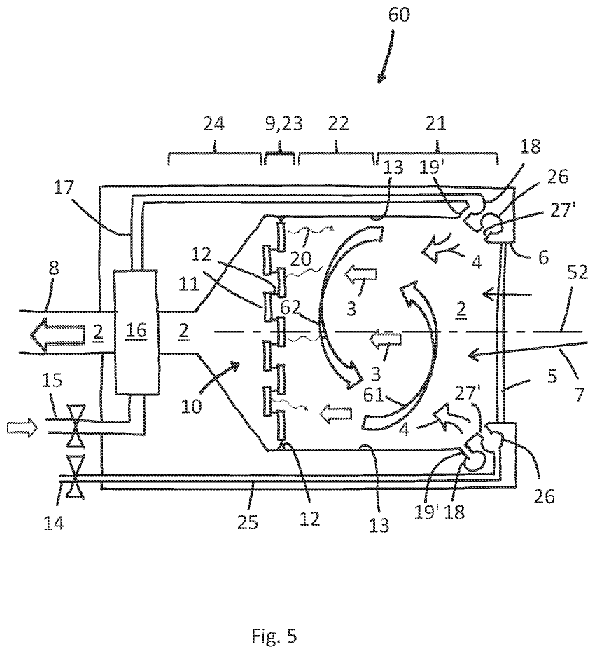

FIG. 5 shows a schematic view of another variant of the receiver reactor with modified feed channels,

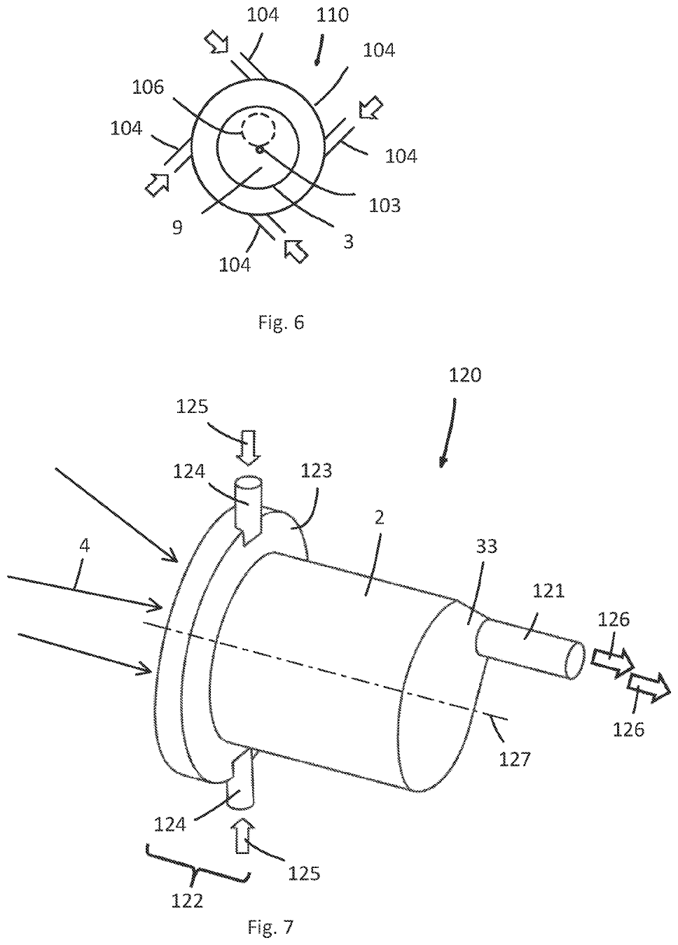

FIG. 6 shows a schematic view of a variant of the receiver reactor according to FIG. 5,

FIG. 7 shows a view of a variant of the receiver reactor according to FIG. 5 in horizontal operating position,

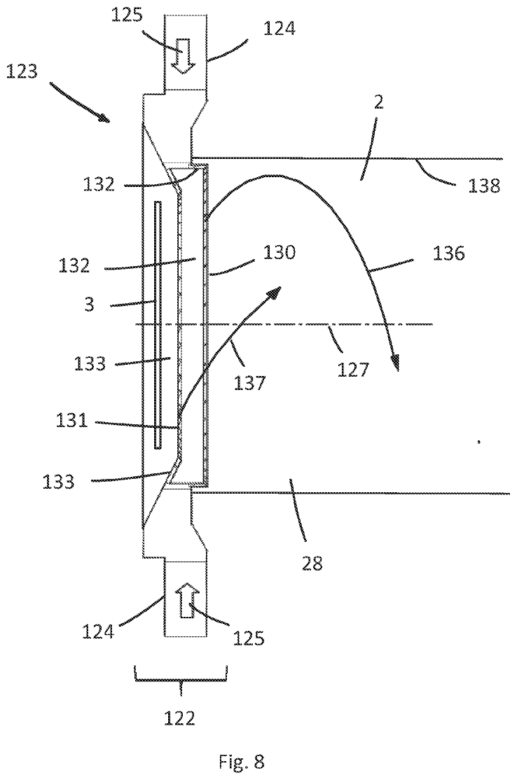

FIG. 8 shows a cross-section through the annular space in the receiver of FIG. 7,

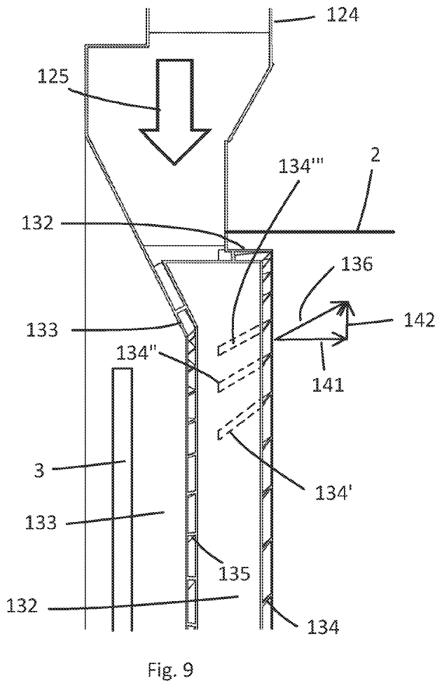

FIG. 9 shows an enlarged detail from FIG. 8,

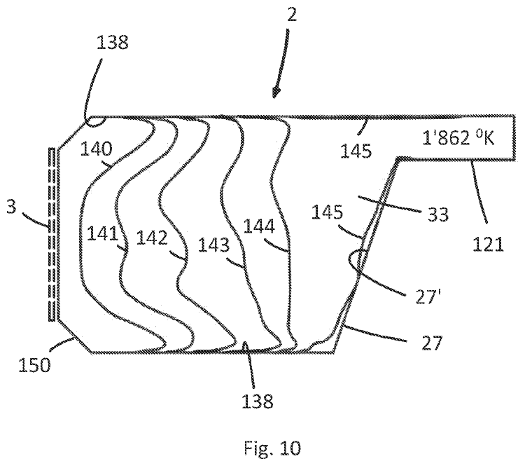

FIG. 10 shows the temperature distribution in the receiver of FIGS. 6 to 9 according to a simulation,

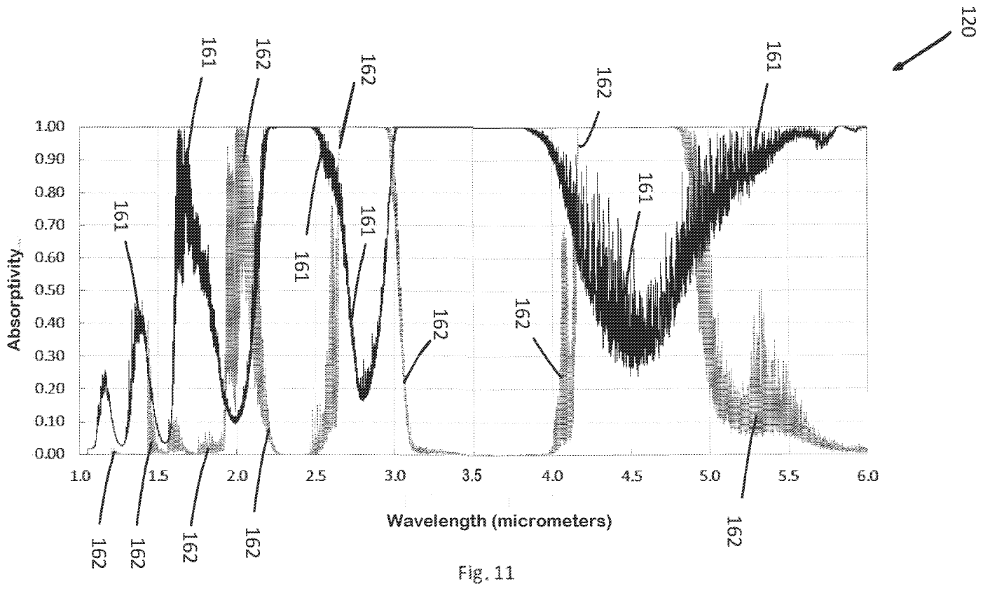

FIG. 11 shows the absorptivity of pure methane and CO₂,

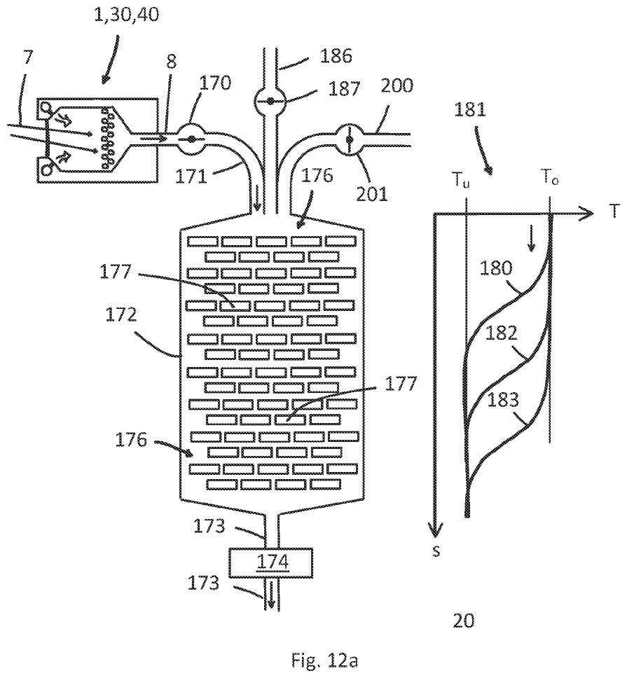

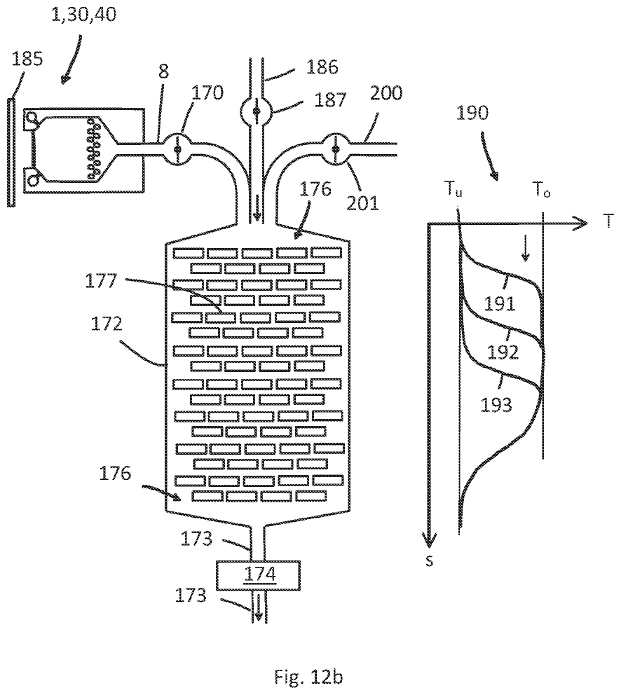

FIG. 12a shows a schematic view of a variant of an assembly for the recovery of heat according to the invention after cracking is complete,

FIG. 12b shows a schematic view of an assembly for using the recovered heat for continued cracking, and

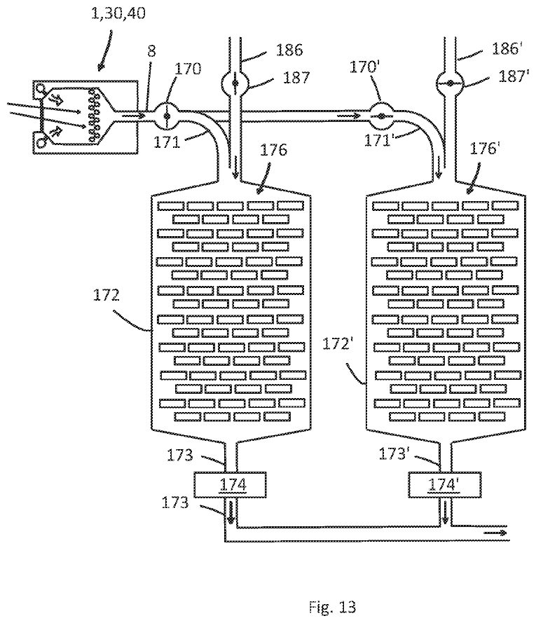

FIG. 13 shows a schematic view of an extended assembly for the recovery of heat with continued cracking.

FIG. 1a shows a longitudinal section through an absorptive receiver reactor 1 according to a first variant, with a flow channel 2—cylindrical in the variant shown—passing through it, for a process gas represented by arrows 3, 4, which channel leads from an aperture 6 for the rays 7 of the sun that is closed off by a window 5 to an outlet 8 from the receiver reactor 1. The rays 7 of the sun fall through the aperture 6 onto an absorber region 9 of the receiver reactor 1, which thus lies in the path of the incident solar radiation (wherein any radiation reflected by the side walls 13 also reaches the absorber region 9) in which in the variant shown an absorber 10 is arranged. Individual absorber panels 11 are connected to each other via struts 12 and suspended in the flow channel 2, thus forming the absorber 10. The absorber panels 11 are arranged such that they are positioned opposite the aperture 6, so that the entire expanse of the absorber 10 is lit by solar radiation 7 falling on it directly during operation. The panels 11 are also offset with respect to each other, so the process gas and the process products can easily flow between the absorber panels 11—the process gas is able to flow through both the absorber region 9 and the absorber 10. Another configuration of the absorber 10, including for example one or two perforated panels arranged one behind the other and then offset relative to each other, is also conceivable. Finally, it is conceivable that the absorber is formed by the rear wall 10′ of the receiver reactor 1 itself, in which case only one outlet 8 or a plurality of outlet channels are provided. The person skilled in the art may construct the absorber or the rear wall embodied as an absorber as appropriate for each specific case.

In operation, a hydrocarbon gas such as methane is fed as process gas to the receiver reactor 1 through a supply line 15, preferably (but not necessarily) preheated in a heat exchanger 16 and delivered to a ring pipe 18 provided at the aperture 6 via a transport line 17, from which it is discharged into the flow channel 2 via feed channels 19, as illustrated by arrow 4. The absorber 10 which has been heated by the solar radiation 7 emits blackbody radiation in the infrared range (on this point, see the description of FIG. 1b), as illustrated by arrows 20.

The process gas flowing in the flow channel in accordance with arrows 3, this case methane, is extremely transparent for the solar radiation 7, but it absorbs the blackbody radiation 20, and is thus heated up absorptively. At this point, it should be noted that for the sake of simplicity from this point on the invention will be described only with reference to methane, but other hydrocarbon gases can also be cracked according to the invention, and methane therefore only stands as an (undoubtedly very important) example of these hydrocarbon gases. The person skilled in the art can now adjust the flow velocity of the methane together with the dimensions of the flow channel 2 and the radiation intensity of the absorber 10 in such a way that on its way to the absorber 10 the methane is heated up to its cracking temperature in a first region 21 of the flow channel 2, in an adjoining second, downstream flow region 22 it is heated to above the cracking temperature, and in a third flow region 23 of the flow channel 2 located farther downstream, it is heated yet further, wherein the third flow region 23 corresponds to the absorber region 9. Regarding the definition of cracking temperature used here, see above and the description of FIG. 4.

In the third flow region 23, or absorber region 9, the methane comes into physical contact with the absorber 10 over the cross-section of flow channel 2, and as a result of the physical contact the absorber functions as a reaction accelerator for the dissociation of the methane, that is to say it is a reaction accelerator with the function of an absorber in a receiver at the same time. In this context, any convective heat transfer from the reaction accelerator in the form of absorber 10 is thus of secondary importance for the dissociation of the methane. The overall effect is that the methane is dissociated or cracked relatively quickly by the physical contact, with the result that in the fourth region 24, after the absorber region 9, a stream of products is formed that contains nanoparticles of carbon and hydrogen, that is to say carbon black and hydrogen. This stream is discharged from the receiver reactor 1 through the outlet 8 after heat has been extracted from it in the heat exchanger 16.

Since the formation of the carbon nanoparticles (carbon black) has already begun to a limited degree in the first region and slowly increases in the second region, a certain amount of the nanoparticles may settle on the absorber 10, in this case on the absorber panels 11, and cling to it as a layer of soot. This is not significant for the continuing cracking of the freshly supplied methane, because the carbon or soot has the preferred properties of the absorber material: it is black, i.e. highly absorptive of the incident solar radiation 7, after the heating it emits the desired (infrared) blackbody radiation, and it is resistant to heat in the region up to well above 2000° C. However, as the deposit grows, the geometry of the absorber 10 also changes in terms of its flowthrough properties until a point at which the cracking is adversely affected. Then, the deposit must be removed appropriately in a (cyclical) maintenance step.

In the case of the variant shown, this is carried out by introducing a second process gas into the reactor receiver 1 through a second supply line 14 via the second transport line 25 feeding it to a second ring pipe 26, and discharging it from this into the flow channel 2 via second feed channels 27, as indicated by arrows 4. The second process gas is preferably a reducible or oxidising gas such as CO₂ or, particularly preferably, steam (or a mixture thereof), which is heated absorptively in the first 21 and the second region 22, and then reacts chemically with the with carbon deposited on the absorber 10 in the absorber zone 9 according to the equation H₂O+C->CO+H₂. In the rest of this description, steam will be used as an example of a reducible or oxidising gas, regardless of whether in the specific case CO₂ or even another carbon oxidising gas or gas mixture can be used. In other words, the receiver reactor then remains productive even during maintenance, and produces syngas as a starter substance for synthetic fuel. In any case, hydrogen production is not interrupted, and with the unmodified use of hydrogen (as opposed to cracking) the carbon monoxide is usable e.g. for producing methanol or other liquid hydrocarbons, by Fischer-Tropsch synthesis, for example.

A receiver reactor is created for cracking a hydrocarbon gas, in particular methane, having an aperture 6 for solar radiation 7, and a flow channel 2 to allow the methane that is to be cracked to flow through the receiver reactor 1, and an absorber region 9 arranged in the path of the incident solar radiation 7, designed for the absorption thereof, and which emits blackbody radiation upstream into the flow channel during operation, wherein the absorber region 9 is arranged and designed in such manner that it is located opposite the aperture 6 for the radiation 7 from the sun, and during operation its entire expanse is illuminated by solar radiation 7 directly incident thereon, and methane is able to flow through it, wherein supply line sections (14, 15) are provided for a hydrocarbon gas and for a carbon oxidising gas (preferably steam), which lines are switchable in such manner that the receiver reactor (1, 30, 40) can be operated alternatingly with the hydrocarbon gas and the reducible gas. Of course, the person skilled in the art can also design the transport lines 17 or 25 so that the respective transport line 17, 25 can be operated sequentially with both process gases, which accordingly renders the other transport line superfluous. According to FIG. 1, preferably two line arrangements (18, 19 and 25, 26) are provided which are independent of each other and open into the flow channel 2.

It further follows that instead of hydrocarbon gas or methane a reducible gas is passed cyclically through the receiver reactor, in such manner that soot deposited in the flow channel 2, particularly in the absorber region 9, is removed during an oxidation cycle by chemical reaction with the reducible gas. As stated earlier, for example CO₂ and/or steam is preferably used as the reducible gas, to such effect that the receiver reactor produces syngas in the oxidation cycle and correspondingly produces carbon black and hydrogen by cracking in the hydrocarbon cycle.

FIG. 1b shows a chart 150 on which the wavelength in μm appears along the horizontal axis in the range from 0 μm to 6 μm, and on whose vertical axis the radiation intensity (corresponding to the energy content) in W/m² μm of electromagnetic radiation is plotted. The curve 151 shows the solar spectrum that is present on the Earth's surface, i.e. the solar radiation 7 after it has passed through the Earth's atmosphere, curve 152 shows the spectrum of a black body at 1500° K.

In a receiver reactor according to the invention, the solar radiation 7 reaches the absorber 10, substantially with the spectrum corresponding to curve 151 since the process gases used according to the invention for the present receiver reactor, for example methane, are largely transparent for this spectrum. As explained earlier, this means that the absorber 10 absorbs the solar radiation and is heated correspondingly, for example to 1500° K or more. As the temperature rises, the absorber 10 itself emits radiation, but with a shifted frequency range, with the consequence that the process gas used is now no longer transparent for this emitted blackbody radiation—it is absorbed by the process gas and heats up correspondingly. It should also be noted that the curve 152 corresponds to the emission of an ideal black body, and the real absorber 10 therefore only approximately follows the spectrum according to curve 152. Moreover, the process gas (hydrocarbon gas) used does not absorb the real spectrum emitted by the absorber 10 completely, but enough to enable the process gas to be heated sufficiently by this greenhouse effect for the cracking according to the invention (on this point, see also FIG. 11).

FIG. 2 shows a schematic view of a longitudinal section through a receiver reactor 30 according to a second exemplary variant of the invention. Unlike the receiver reactor of FIG. 1, the absorber region 9 does not have a permanently installed absorber, but instead an apparatus 31 for generating a cloud of particles 32, which upon physical contact with the methane trigger cracking thereof as seed cells for the cracking, i.e., it fulfils the function of an absorber and a reaction accelerator, and has an effect as such. These particles preferably consist of soot particles 32, which are sprayed through nozzles 33 from a supply line 34 to form a gas-particle mixture into the methane which is flowing through the flow channel 2 as indicated by arrows 3, with the result that a permanent cloud of particles and/or soot particles 32 is formed in the absorber region 9 (that is to say in the third region 23), which cloud is heated absorptively by the incident solar radiation 7, thus itself emits blackbody radiation 20 and so heats the flowing methane in the first region 21 to its cracking temperature and in the second region 22 beyond this temperature. The cloud of particles extends over the cross-section of the flow channel 2, and in the third region 23 functions as a reaction accelerator for the cracking (on this point, see also the description of FIG. 4), wherein the carbon that is formed by the cracking settles on the particles or soot particles 32 and is discharged from the reactor receiver 30 through the outlet 8. In case undesirable deposits on the section of the supply line 34 that protrudes into the flow channel 2 are to be removed, the person skilled in the art may provide for example a steam circuit according to the variant described in FIG. 1. In the specific case it is also possible to direct the nozzles 33 towards the aperture 6, so that the particles or soot particles 32 are sprayed out against the flow of the methane (arrows 3). This may be advantageous with regard to carbon deposits, because soot that has already formed is less likely to be deposited than soot which has formed during the cracking initiated by physical contact with the line 34.

A receiver reactor 30 is created for the cracking of methane, having an aperture 6 for the radiation 7 of the sun, and a flow channel 2 for transporting the methane that is to be cracked through the receiver reactor, and an absorber region 9 which is located in the path of the incident solar radiation 7, designed for the absorption thereof, and which emits blackbody radiation upstream into the flow channel 2 during operation, in which the absorber region 9 is positioned and constructed in such manner that it is located opposite the aperture 6 for the solar radiation 7, and during operation its entire expanse is illuminated by solar radiation 7 directly incident thereon, wherein the absorber region 9 further includes an apparatus 31 for generating a cloud of particles (preferably soot particles 32). In order the generate the particles, the apparatus is preferably equipped with at least one spray nozzle 33 for particles, preferably soot particles 32.

In addition, a process is created, according to which a cloud of particles 32 in is sprayed into the flowing methane in the third flow region 23, preferably with the receiver reactor 30 represented in FIG. 2, in such manner that the cracking is initiated over the cross-section of the flow, and wherein the cloud is formed in such manner that it lies in the path of the incident sunlight 7 and absorbs said sunlight, is warmed thereby and also emits blackbody radiation 20 upstream into the flowing methane.

FIG. 3a shows a schematic view of a longitudinal section through a receiver reactor 40 according to a further variant. An absorber 41 is provided in the absorber region 9, and is equipped with a number of—in this case rod-like—absorber elements 42, which in turn may be moved in the direction of the double-headed arrow 44, advanced into an operating position in the absorber region 9 of the flow channel 2 or withdrawn into an idle position outside the absorber region 9 via a movement apparatus 43 indicated only in outline here. The person skilled in the art can construct the movement apparatus 43 appropriately for the specific case. Absorber elements 42 whose functionality is adversely affected by deposits may be withdrawn from the absorber region by means of the movement apparatus 43 and replaced with absorber elements 42 that do not have any damaging deposits. This can be carried out while the reactor receiver 40 is in operation by replacing the individual absorber elements a few at a time, or as deposits are detected, or all at once, during the night for example.

FIG. 3b shows a schematic view of a longitudinal section through the receiver reactor 40 which is orientated perpendicularly to the length of the absorber elements 42 of FIG. 3a. The two rows of absorber elements 42 are shown in a staggered arrangement one behind the other, wherein of course only one or more than two rows may equally well be provided.

A receiver reactor is created for the cracking of a hydrocarbon gas, in particular methane, having an aperture for the radiation of the sun, and a flow channel for transporting methane that is to be cracked through the receiver reactor, and an absorber region located in the path of the incident solar radiation, designed for the absorption thereof, and which emits blackbody radiation upstream into the flow channel during operation, in which the absorber region is positioned and constructed in such manner that it is located opposite the aperture for the solar radiation, and during operation its entire expanse is illuminated by solar radiation directly incident thereon, and so that the hydrocarbon gas—in this case methane—is able to flow through it, wherein an absorber is further provided in the absorber region and includes absorber elements which are movable independently of each other between an operating position in the absorber region and a replacement position outside the absorber region, and a movement apparatus for the absorber elements.

The movement apparatus is preferably designed to change a current operating situation of the absorber elements in their operating position in predetermined manner.

The movement apparatus is also preferably designed to allow used absorber elements in the idle position to be swapped out for fresh absorber elements.

In this context, an absorber or parts of the absorber will be swapped out or cleaned after a scheduled threshold of deposits is reached, preferably during active operation.

In a further, preferred variant, the flow channel 2 is tubular with a straight axis, wherein the window 5 is located at one end and transversely to the axis thereof, and the absorber region 9 is located at the other end thereof and is also orientated transversely to the axis and extends over the entire cross-section of the flow channel 2 at that point. It should be noted here that the tubular or cylindrical design of the flow channel 2 may be provided for all of the variants according to the invention. The person skilled in the art can design the flow channel 2—and the absorber—appropriately for the specific case.

FIG. 4 shows a schematic view of the longitudinal section through the receiver reactor 40 of FIG. 3b together with a chart 50 of the temperature distribution in the first 21 to the third 23 region of the flow channel 2 during operation of the receiver reactor 40. The distance A from the window 5 to the end of the absorption region 9 is plotted on the horizontal axis, the temperature T is plotted on the vertical axis. Again, arrow 3 symbolises the direction of flow of the methane. But the conditions represented in chart 50 also apply analogously for each variant of the receiver reactor according to the invention and with regard to the process according to the invention for cracking a hydrocarbon gas.

Curve 51 shows the temperature progression on an axis 52 of the flow channel 2, curve 53 shows the progression close to the side walls 13, and curve 54 shows the average temperature progression of the methane flowing through the absorber 41 from the window 5 (or in the cyclical operation according to the description of FIG. 2, of the oxidising gas or steam as well).

The curves are only shown qualitatively in the figure, but they are based on a mathematical model of an absorptive receiver manufactured by the Applicant, which is designed with a straight, tubular flow channel 2 as shown in FIGS. 1 to 4. The system has been modelled using the most accurate method currently available, specifically “Spectral line-by-line (LBL) photon Monte Carlo raytracing”, wherein the absorption coefficients are taken from the FIITEMP 2010 Spectroscopic Database. Modelling was carried out for a receiver whose absorption chamber (regions 21 to 23) has a diameter of 15.96 m and a height of 15.96, and whose aperture 6 has a diameter of 11.28 m. These dimensions result in a directly illuminated area of the absorption chamber 9 equivalent to 200 m² and an area of the aperture 6 equivalent to 100 m². Steam was assumed as the heat transporting medium (wherein in the case of methane there are no qualitatively significant changes), under pressure of 1 bar, with no window in the aperture 6. The radiation flow is 1200 kW/m² at the aperture 6 and 600 kW/m² in the absorbing region (9) (which has twice the area of the aperture 6). This modelling can be applied to the centre or the walls of the flow channel 2 in terms of the temperature conditions and the average temperature, and particularly in view of the relatively low input temperature of the methane for the cracking upon entry into the flow channel 2. In particular, these curves illustrate the constant rise in temperature in the flow channel 2 brought about by the absorptive heating, and the reduced deviations of temperature from the respective average value for the region close to the wall and the axial region of the flowing methane which are significant for the cracking process.

The methane passes through the ring pipe 18 (preferably after preheating by the heat exchanger 16) and is discharged into the flow channel 2, the distance A in chart 50 is zero. Because the side walls 13 are heated by the blackbody radiation 20 (or also by solar radiation 7 falling obliquely through the window 5), the methane in the region close to the walls heats up to the cracking temperature Tₑ relatively quickly. As explained earlier, here the term cracking temperature is used for the temperature at which 50% of the methane is dissociated in the steady state condition, i.e. after an infinitely long period.

However, the steady state condition is not reached in the first region 21 of the flow channel 2 due to the continuing flow (arrows 3) and the sluggish reaction; the percentage of dissociated methane is significantly lower than is suggested by the corresponding average temperature (curve 54). Thus, at the end of the first region 22 (distance A₂₂), in which the average temperature reaches the cracking temperature Tₑ, the cracking has only just started. Meanwhile, there are zones close to the wall that are enormously overheated relative to the cracking temperature, i.e. zones in which the (slow) cracking continues, and zones in the middle of the flow channel 2 which are significantly too cool, in which the cracking is not yet taking place. In other words, the dissociation process in region 21 begins unevenly.

At the end of the second region 22 (distance A₂₃), the average temperature (curve 54) is significantly higher than the cracking temperature Tₑ, and the difference between the temperatures close to the wall and in the middle (curves 53 and 51) has become smaller—the cracking has been initialised over the entire cross-section of the flow channel 2. But here too, the dissociation is not as far advanced, and not yet as homogeneous as would correspond to the steady state condition at the average temperature (curve 54). Given the temperature and the time that has elapsed (steady state condition), there is still only a very small fraction of cracked methane, which would not be sufficient for an economically justifiable operation of the receiver reactor.

In the third region 23, that is to say of the absorber zone 9, the methane comes into physical contact with the reaction accelerator, which is embodied as an absorber, for example either in the form of a permanently installed absorber 10,42 as shown in FIG. 1 or 3a, b, or in the form of a cloud of particles 32 according to FIG. 2. As it passes through the absorber zone 9, the temperature of the methane rises rapidly due to absorptive heating, the temperature deviations between the average temperatures at the wall 13 and the axis of the flow channel 2 become smaller and cannot interfere with the homogeneity of the dissociation reaction over the cross-section of the absorber region 9, and are therefore no longer significant for the cracking process itself.

In detail, the passage of the methane through the third region 23 or the absorber zone 9 leads to two effects: Firstly, the methane molecules are heated very sharply by the intensive infrared radiation shortly before the physical contact, they dissociate or are overheated very strongly (relative to the cracking temperature). Secondly, the physical contact functions as a seed cell for the dissociation, which then takes place rapidly and almost completely through the overheating of the methane. As was explained earlier, a certain deposit of soot on a permanently installed absorber 10, 42 is unavoidable here, although these deposits, which do not interfere with the cracking itself can be eliminated overnight, for example, or by solar operation with an oxidising gas. It may be noted that a reaction accelerator as shown in FIG. 2b in the form of an absorbing particle cloud is particularly beneficial with regard to deposits, because the deposits form on the particles 32, which are then discharged from the receiver reactor 30 through outlet 8 with the stream (now consisting of soot particles and hydrocarbon gas).

The result is that staggered temperature zones form one behind the other in the flow channel (these are divided roughly into three regions 21 to 23 in the description), refer to the dashed lines in FIG. 4 for the zones 60 to 67 assume here. Of course, these zones 60 to 67 extend throughout the length of the flow channel 2, but in order to minimise unnecessary detail in the figure the dashed lines are only drawn as far as the side wall 13 of the flow channel 2.

Regardless of exactly where the zone boundaries are set, it can be observed that they extend transversely to the flow channel 2, they are disc-shaped, and the temperature increases from each temperature zone to the next temperature zone through absorption, although of course it is impossible for an entirely homogeneous temperature distribution to exist in each temperature zone, a slightly inhomogeneous temperature distribution subsists (each temperature zone 60 to 67 has its own respectively higher temperate level), but at least from the second flow region 22 the temperature boundaries are increasingly closer to each other (at the start of the first flow region, see zone 60, this is not yet the case due to the nature of the process). Consequently, after the second flow region 22 a practically complete and for the purposes of the cracking uniform heating of the methane is obtained, so that the cracking can be carried out with a very high degree of dissociation, which satisfied industrial requirements. Moreover, the receiver reactor 1, 30, 40 is suitable for continuous operation, wherein carbon deposits can be removed continuously or overnight (see the descriptions for FIGS. 1, 3a and 3b) or are substantially prevented (see the description for FIG. 2).

In general, according to the invention a process is provided for cracking hydrocarbon gases, preferably methane, wherein the hydrocarbon gas is directed through a flow channel of a receiver reactor, and wherein the cracking takes place while it passes through the receiver reactor, wherein in a first region of the flow channel the methane is heated to its cracking temperature, in an adjoining second, downstream flow region it is heated beyond the cracking temperature, and in a third region of the flow channel, farther downstream, the methane is heated further still, and in this region over the cross-section thereof is brought into physical contact with a reaction accelerator, after which the stream of products is discharged from the receiver reactor behind the reaction accelerator, and wherein the hydrocarbon gas is heated to beyond its cracking temperature by absorption of blackbody radiation, which is given off by the reaction accelerator heated by the solar radiation incident thereon to the hydrocarbon gas flowing towards it, in such a way that the methane in the flow channel and extending up to the reaction accelerator forms disc-shaped, consecutively staggered temperature zones, each of increasing temperature.

In this process, an absorber of the receiver reactor through preferably serves as the reaction accelerator, through which the medium flows having been directed through the receiver reactor.

The hydrocarbon gas is thus heated absorptively in the first and second regions of the flow channel (regardless of the absorber or reaction accelerator used), the heating in the third region of the flow channel also takes place absorptively, wherein a convective heat transfer might be effected at the absorber which functions as the reaction accelerator through physical contact, but this is practically superfluous in comparison with the quantity of heat taken up absorptively, as the hydrocarbon gas has already been raised to the temperature required for cracking absorptively and the dissociation takes place upon physical contact. It should further be noted at this point that the walls of the flow channel 2 also give off blackbody radiation, particularly in the regions 21, 22, and this is also absorbed by the hydrocarbon gas. Accordingly, it is here defined that in the feature described above, according to which the heating of the hydrocarbon gas to beyond its cracking temperature is effected by absorption of blackbody radiation that is given off to the hydrocarbon gas flowing towards it by the reaction accelerator heated by solar radiation incident thereon, such blackbody radiation given off by the walls is explicitly included therewith.

It should be noted that the variants presented in the present description can be combined, and accordingly the person skilled in the art can combine replaceable absorber elements as described in FIGS. 3a and 3b with a cloud of particles 32 according to FIG. 2 depending on the specific case, or additionally provide for the removal of carbon deposits with the aid of an oxidising gas in accordance with FIG. 1.

Constructions are also used in a solar tower power plant in which the receiver (in this case a receiver reactor according to the present invention) is disposed at the top of the tower and inclined downwards in order to collect the radiation from the heliostat array directly. Because of the inclined orientation it is possible that correspondingly inclined temperature zones 60 to 67 may be created, which may give rise to a convection stream in the heat transporting fluid, which in turn may disrupt the temperature stratification created by the temperature zones and therewith the desired maximum possible homogeneity of the temperature distribution in the third region 23 and/or in the absorber zone 9 as well.

With other constructions in a solar tower power plant for example, the receiver reactor according to the invention may be aligned vertically, in which case the radiation from a heliostat array is directed vertically downwards via mirrors arranged in the solar tower towards the receiver 100 which is located close to the ground, such an arrangement is known to the person skilled in the art as “beam-down”. (Conversely, the radiation from the heliostat array can also be directed vertically upwards via mirrors or by the heliostats themselves, wherein the receiver 100 is then located on top of the solar tower.)

Particularly in a receiver 100 which is orientated vertically downwards, the flow of the fluid that is transported through the absorber chamber 28 is extremely even, and consequently a clear temperature stratification is obtained over the height of the absorber chamber 28. In the case of a “beam-down” arrangement, depending on the specific case it may be beneficial to provide not only a sufficiently high flow velocity of the heat transporting or absorptive fluid such as methane towards the absorber but also to introduce a spin in the fluid, as presented in FIGS. 5 to 10, which will be described below.

For this reason, according to a further variant of the receiver reactor 1, it is provided according to the invention to introduce process gas, at least the hydrocarbon gas, which is to be cracked, or even the reducible gas, into the flow channel 2 tangentially through the correspondingly modified feed channels 19′ and 27′ as shown in FIG. 5, in such a way that the gas flowing in the direction of arrows 3 also rotates about the axis 52. Then, the outlet 8 may also be shifted slightly away from the middle of the flow channel 2, so that it lies close to its top side, in the specific case, for example, with the receiver 60 mounted in a tilted position.

To this end, the feed channels 19′ and 27′ are preferably constructed so that they open into the flow channel 2 tangentially and create an additional twist as shown by arrows 61 and 62 in the flow of the respective process gas. As a result, the temperature zones 60 to 67 according to chart 50 of FIG. 4 are retained even when the receiver reactor 60 is in a tilted position.

In case the outlet 8 is arranged off centre with regard to the flow channel 2, the process gas may rotate about an axis correspondingly parallel to the axis 52.

Thus, the receiver reactor 60 is designed in such a way that the feed channels are constructed tangentially to a longitudinal axis (52) of the flow channel 2, so that when the receiver reactor 60 is in operation the process gas in flow channel 2 has a twist about this axis 52 on its way to the absorber region (9).

It should be noted at this point that the rotation of the stream or the twist may also be produced by deflector plates in the flow chamber 2, which is preferably effected in first region 21 thereof due to the defined temperature stratification, so that the cost of the receiver reactor 60 according to the invention is not increased significantly.

FIG. 6 shows a schematic view of a receiver 110 arranged in a tilted position towards the side of its aperture 3 for the radiation of the sun, showing supply lines 104 for the radiation absorbing medium (the process gas) arranged tangentially to the axis 103, which produce a rotation or twist in the medium that is flowing towards the absorber 27. The absorber 27 is visible in the figure through the aperture or the quartz window 3, wherein in order to minimise the detail in the figure the flow path of the medium through the absorber (or past it) is not shown, and instead only an outlet pipe end through which the medium exits the receiver 110 is indicated with a dashed line 106. The outlet pipe end is preferably located slightly above centre, which when combined with the twist in the flowing medium serves to stabilise the temperature in the heat transporting medium at the site of the outlet pipe end 106.

Thus, the receiver reactor is preferably constructed in such manner that during operation as the process gas is passing through the flow channel 2 in the direction of transport it has at least a partial twist about an axis 52 of the absorber chamber parallel to a direction of transport, wherein the receiver reactor preferably has inlet apertures for the medium provided on the flow chamber 2, which apertures are aligned tangentially to the axis 52 thereof in the same twist direction.

It should be noted at this point that the rotation of the stream or the twist may also be produced by deflector plates in the flow channel 2, which is preferably effected in the cold region thereof due to the defined temperature stratification, so that the cost of the receiver reactor according to the invention is not increased significantly.

FIGS. 7 to 10 show details of a receiver reactor 120 that is designed for high efficiency even when mounted in a tilted or horizontal position. FIG. 7 shows an external view of the receiver reactor 120, FIGS. 8 and 9 show a cross-section through the reactor, and FIG. 10 shows the stratified temperature distribution in the flow channel 2 thereof according to simulation by the Applicant. In order to reduce the detail in the figures, the insulation of the receiver reactor 120 as well as its supporting external structure, which the person skilled in the art will easily be able to envisage, has been omitted.

FIG. 7 shows the receiver reactor 120, with its flow channel 2, a collecting chamber 33 and an outlet end pipe 121 (on this point, see also the notes on FIGS. 1 and 5). Also discernible is a supply arrangement 122 for cold (Tᵢₙ) process gas. The supply arrangement 122 includes an annular chamber 123 into which supply lines 124 for process gas discharge, as indicated by arrows 125, wherein process gas that has flowed through the annular chamber 123 into the receiver 120 passes across the flow channel 2 in a primary stream direction parallel to the axis 127, is heated in the process and after cracking finally exits the receiver 120 again via collecting chamber 33 and outlet end pipe 121 at temperature Tₒᵤₜ (arrows 126). Solar rays 4 reach the flow channel 2 through an aperture or window 3 which is concealed in the figure by the annular chamber 123 as far as the inside of the collecting chamber 33, the inner wall of which is embodied as an absorber for solar radiation in the variant shown. As was explained in the description of FIG. 6, in the variant shown the outlet end pipe 121 is also offset upwards.

FIG. 8 shows a cross-section through the annular chamber 123, wherein the section plane again passes through an axis 127 extending lengthwise through the flow channel 2 and the supply lines 124 (see also FIG. 10). In this instance, the annular chamber 123 is shown to scale, as is the adjacent region of the flow channel 2 and the situation of the aperture 3 or a window 3 for the radiation from the sun. As was noted previously, however, the insulation and the supporting structure have been omitted, here particularly those for the window 3 and the annular chamber 123. The upstream or inlet-side supply lines 124 for the process gas are also shown here. Downstream or on the outlet side, the annular chamber 123 is divided into an outer ring channel 132 with an annular outlet slit 130 and an inner ring channel 133 with an annular outlet slit 131. The outer channel 132 extends coaxially with the axis 127 of the flow channel 2 and adjacent to the wall 138 thereof, the inner channel 133 has a truncated cone configuration and is orientated at an angle towards the interior of the absorption chamber 28. As a result, zones with reduced flow towards the absorber in the region of the wall 138 are only created to a lesser degree or to a degree that is no longer significant, wherein a homogeneous temperature stratum is finally obtained (on this point, see also FIG. 10) before the absorber over the cross-section of the flow channel 2 despite the slightly hotter walls (see chart 50 in FIG. 5) finally. Therefore a flow component particularly preferably extends from the outer channel 132 parallel to the wall 138, its angle with the wall 130 is preferably less than or equal to 15 degrees, particularly preferably less than or equal to 10 degrees, and most particularly preferably less than or equal to 5 degrees. A positive effect can still be achieved with an angle less than or equal to 10 degrees or 15 degrees.

The ring channels 132, 133 are furnished with deflector plates 134, 135 (see FIG. 11b), with the result that apertures for the process gas are formed in the outlet slits 130, 131 and also lend it a flow component tangential to axis 127. Consequently it enters the flow channel 2 in a directed stream and has a (twisted) flow direction tangential to axis 127 besides the primary flow direction parallel to the axis 127. This gives rise to the spiral flow lines 136 and 137 shown in the figure for exemplary purposes. Thus, a disturbance of the temperature stratification in the receiver 120 can be suppressed for example by temperature-induced convection streams, particularly for inclined or horizontal orientation.

FIG. 9 shows an enlarged detail from FIG. 8 to clarify the conditions. In particular, it shows the deflector plates 134′ to 134′″ and the components of the directed flow 136, specifically those in the direction of the primary flow 141 and the tangential component 142.

A receiver reactor is created which has apertures for the process gas which lead into the flow channel 2, and which are arranged adjacently to a wall 138 of the flow channel 2, which produces a flow component of the process gas flowing in the primary flow direction into the flow channel 2 with an inclination relative to the wall 138 of less than 15 degrees, preferably equal to or less than 5 degrees. According to the Applicant's findings, such small angles can be helpful in avoiding zones of reduced flow velocity towards the absorber in the region of the wall 138 which have a bearing on the efficiency of the absorber.

In addition, a receiver reactor is obtained in which the transport arrangement includes apertures leading into the flow channel 2 for the heat transporting and absorbing medium, and which produces a flow component of the process gas flowing into the absorption chamber 28, which component is tangential to an axis 127 of the flow channel 2.

Finally, a process is created for operating a receiver reactor, in which the process gas is caused to rotate in a flow channel 2 in such manner that it has a twist about an axis (127) extending in the direction of transport and the primary stream direction in the flow channel 2.

FIG. 10 shows the temperature distribution in the flow channel 2 of the receiver reactor 120 according to a CFD Simulation performed by the Applicant with the following boundary conditions:
diameter of the absorption chamber 0.8 m, pressure in the flow channel=1 bar
Tᵢₙ=800° K, mass flow of the process gas=0.045 kg/s
Solar radiation output through the transparent aperture 3=250 kW, diameter of the aperture: 0.6 m
process gas: Steam
spectral radiation behaviour of steam modelled with weighted sum of grey gases (WSGG) model and radiation resolved with the discrete ordinates (DO) method
black walls, ε_{wall}=1
gravity facing vertically downwards (horizontal receiver)
angle of the fluid flowing into the absorption chamber: 45 degrees

The angle of the inflowing fluid in the ring channel 132 is the angle between the directed flow 136 and the direction of the primary flow 141 from FIG. 9. As noted earlier, the ring channel 133 has a truncated cone configuration, i.e. its downstream end is circular. The angle of the fluid flowing out of this and into the absorption chamber is similarly the angle between its flow direction and a tangent on this circle.

In this context, for the simulation a simplified geometry was assumed in the region between the optical aperture 3 and the walls 138 of the flow channel 2: the space between the outlet slits 130 and 131 (FIGS. 8 and 9) is replaced by a wall region 150 in the shape of a truncated cone.

The simulation reveals an outlet temperature Tₒᵤₜ of 1862° K and the temperature stratification shown in the figure which is represented by the temperature curves 140 to 145. The temperature curve 140 corresponds to the temperature 1420° K, the curve 141 corresponds to the temperature 1533° K, the curve 142 1589° K, the curve 143 1645° K, the curve 144 1702° K, and the curves 145 correspond to 1870° K.

It was found that, despite the complex thermodynamic conditions, even at very high temperatures caused among other factors by the hot wall 138, also heated by the radiation from the absorber 27 and the complex flow conditions, caused among other things by the convection current induced by the temperature differences and gravitation, a temperature stratification exists in the process gas (in this case steam), in which the temperature increases steadily from the aperture 3 to the outlet end pipe 121, with the consequence that for example the efficiency-impairing back radiation can be minimised by the aperture 3. It should also be noted that the person skilled in the art is able to specify the direction of the inflow and the twist or rotation of the fluid in the absorption chamber about an axis extending through said chamber suitable for the case at issue, as well as the location of the outlet end pipe (central in accordance with FIGS. 2 and 3 to 6 or offset according to FIGS. 9 and 10). For example, if an optimum twist can be created in the context with the other parameters (for example those of the simulation above), the outlet end pipe can also be arranged centrally in the case of horizontal orientation. Conversely, the combination of a relatively weak or non-optimal twist with an offset position of the outlet end pipe can produce the desired temperature stratification.

In a further variant according to the present invention, CO₂ is fed into the flow channel 2 as well as the hydrocarbon gas in the hydrocarbon gas cycle, i.e. during the cracking; it mixes with the hydrocarbon gas, heats it up and passes into the third region 9 (FIGS. 1 to 5) with it. As a result, according to the Applicant's calculation (FIG. 11) an unexpected increased thermal efficiency of the receiver reactor was achieved, particularly for the combination of methane with CO₂, as well as the further advantage in that more syngas components that is to say CO as well as H₂, can be produced.

FIG. 11 shows a chart 160 in which the horizontal axis shows the wavelength in μm and the absorptivity of electromagnetic radiation by an absorbing gas is plotted on the vertical axis, wherein the value 1 for absorptivity is reached when a gas absorbs 100% of the radiation at the wavelength in question, i.e. 100% of its energy content.

Curve 161 shows the absorptivity of methane, curve 162 shows the absorptivity of CO₂, according to a calculation by the Applicant with the following assumptions: pressure=1 bar, path length=10 m, based on the data of the Reims database for methane and the HITEMP 2010 database for CO₂.

If one of the curves 161, 162 has a value less than 1, it follows that a corresponding fraction of the radiation at the frequency in question is not absorbed and consequently passes from the absorber 10 through the process gas and reaches the window 5 of the receiver reactor, where it exits the receiver reactor are back radiation. However back radiation is indicative of reduced efficiency of the receiver reactor, since the heat supplied via solar radiation 7 as part of back radiation cannot be used to heat the process gases. A real absorbing gas thus results in reduced efficiency of an absorptive receiver and correspondingly to reduced production of hydrogen and carbon during cracking. According to the invention CO₂ is now added to the methane in the hydrocarbon gas cycle, with the consequence that absorption is substantially equivalent to 1 over the wavelength range at least from 1.5 μm to 6 μm, since roughly speaking either the methane or the CO₂ is practically entirely absorbed. A compelling example is the wavelength range between 3.1 μm and 3.9 μm, in which absorption of methane is practically zero, but that of CO₂ is close to 1. Accordingly, back radiation is reduced considerably compared with just methane as the process gas, with the result that more heat is produced in the receiver reactor, which in turn raises the degree of efficiency commensurately.

As noted previously, besides the higher degree of efficiency a double chemical reaction now takes place, namely the cracking of methane and a reaction between methane and CO₂, summarised in the reaction equation 1CH₄+½CO₂->½C(s)+2H₂(g)+1CO(g), wherein (s) denotes a solid and (g) a gaseous phase. It is thus found that compared with the cracking itself, having reaction 1CH₄-->1C(s)+2H₂(g), not only is the degree of efficiency greater but CO is also recovered as a further syngas component.

The person skilled in the art may fix the ratio of hydrocarbon gas to CO₂ as appropriate for the specific case, wherein methane is preferably used as the hydrocarbon gas and the number of moles of methane to the number of moles in the mixture of methane and CO₂ in the third region (23) of the flow channel (2) is equal to 60 to 90%, preferably 60-70%, particularly preferably 66.67%. In this context, the proportions are not specified until the third region (23), since in the specific case it was also not possible to feed in the CO₂ until the start of the second region 22, preheated for example via heat exchanger 16 (see for example FIG. 3a).

FIG. 12a shows an arrangement for recovering the heat from the products of the receiver reactor 1, 30, 40, that are discharged through the outlet 8, the temperature of which is preferably still at the temperature level prevailing in the third flow region 23 and absorber region 9. The products are not cooled before the outlet 8 in particular if blackbody radiation is also given off towards the outlet 8 by the absorber 10, 32, 42 (and the side walls in front of the outlet 8), and is absorbed by the products according to their absorptivity. After the outlet 8, the products pass through the shut-off valve 170 and into a first line arrangement with a line 171 that connects the receiver reactor 1, 30, 40 with to a heat accumulator reactor 172. During daytime operation of the receiver reactor 1, 30, 40, that is to say when there is enough solar radiation 7 to enable cracking to proceed in the receiver reactor 1, 30, 40, the shut-off valve 170 is open, the products from the receiver reactor flow into the heat accumulator reactor 172 and charge it with heat, i.e. they are cooled therein and exit through the line 173, wherein a filter 174 for the carbon particles may be provided in this line 173 so that finally H₂ is discharge from the line.

The heat accumulator reactor 172 is embodied as a stratified solid state heat accumulator with a filling of bulk material as solid-state heat accumulator elements, as described for example in WO 2012/027 854; the warm products from the receiver reactor 1, 30, 40 pass through the filling, heating it, so that the heat accumulator reactor 172 is charged with heat. In the variant of the heat accumulator reactor 172 shown in FIGS. 12a, 12b, the filling of bulk material has a structure of fire-resistant material such as ceramic blocks 177, which are located inside the flow channel 176 of the heat accumulator reactor 172 and are arranged in such manner that the products flow over and around them (and if they are permeable or porous, through them as well) with physical contact. The structure of the bulk material such as the ceramic blocks 177 may be defined by the person skilled in the art depending on the specific case.

During operation, when charging of the heat accumulator reactor 172 begins, first the topmost layer of ceramic blocks 177 is heated by the products from the receiver reactor 1, 30, 40 as they pass through them to an upper temperature Tₒ, wherein the products themselves cool down and warm the following layer of ceramic blocks 177 to a slightly lesser degree, and so on until the products flow through the subsequent layers of the ceramic blocks 177 at a lower temperature Tᵤ and are finally discharged at temperature Tᵤ via the discharge line 173. A temperature distribution is reached in the heat accumulator reactor 172 as shown by the temperature curve 180 in chart 181, the horizontal axis of which represents the temperature and the vertical axis shows the distance in the flow direction through the flow channel 176.

As charging progresses, the curve 182 shows the heat distribution in the accumulator 172. Finally, the curve 183 corresponds to the temperature distribution in the fully charged accumulator 172. In other words, the operation is such that while the accumulator 172 is being charged the ceramic blocks 177 are warmed to the upper temperature Tₒ one layer at a time from top to bottom, until the point is reached at which if charging were to continue further the temperature of the products in the line 173 would rise above the lower temperature Tᵤ, because even the bottom layer of ceramic blocks 177 would have been heated.

A process is provided in which preferably a warm stream of products discharged from the receiver reactor (1, 30, 40) after the reaction accelerator is transported via a first line arrangement to a stratified heat accumulator reactor 172 with solid state heat accumulator elements 177 and is then directed through it, in such a way that it is charged with heat recovered from the products up to a temperature Tₒ above the cracking temperature. In addition, a receiver reactor is created, whose outlet 8 is connected to a stratified heat accumulator reactor 172 via a first line arrangement, the wherein the accumulator reactor has an internal flow channel 176 for transporting the products from the receiver reactor 1, 30, 40, in which again solid-state heat accumulator elements 177 are arranged in such a manner that the transported products flow around and through them and come into physical contact with them.

For information about the lines 186 and 200 with the shut-off valves 187, 201 see the description for FIG. 12b below.

FIG. 12b shows the arrangement for heat recovery of FIG. 12a in night-time operation, i.e. when the receiver reactor 1, 30, 40 is not in operation, whether at night, for maintenance, when insufficient solar radiation is present. This is symbolised by the plate 185 which shields the receiver reactor from the sun. The shut-off valve 170 is closed accordingly. A second line arrangement with a line 186 leads from a hydrocarbon gas source (e.g., methane) to the heat accumulator-reactor 172, wherein a shut-off valve 187 is opened in the line 186 so that the hydrocarbon gas can flow into the heat accumulator reactor 172 in the direction of the arrows in the line 187.

In the region of the topmost layers of the ceramic blocks 177 the hydrocarbon gas is heated up to temperature Tₒ, which is considerably higher than the cracking temperature, see the description above. The ceramic blocks 177 cool down, the heat accumulator reactor 172 is now discharged. The ceramic blocks 177 in contact with the hydrocarbon gas function as a reaction accelerator, similar to the cracking in the receiver reactor 1, 30, 40, see the description of cracking in the receiver reactor above. Consequently, cracking of the hydrocarbon gas takes place in the heat accumulator reactor 172, wherein the products of the cracking continue flowing through the heat accumulator reactor 172 and are finally discharged to the outside through line 173. The chart 190 shows the temperature distribution in the heat accumulator reactor 172 after discharging begins with curve 191, at a time during the discharge with curve 192, and after the heat accumulator reactor is discharged and ready for a new charge according to the description of FIG. 12a with curve 193. It should be noted here that the cracking is endothermic, so energy needed therefor is recovered from the cooling of the ceramic blocks 177.

A process is created in which a heat accumulator reactor, preferably charged with heat, is discharged by cracking of hydrocarbon gas therein. A process is also created in which hydrocarbon gas, preferably methane, is fed preferably to the heat accumulator-reactor via a second line arrangement from a hydrocarbon gas source and is then passed through it, wherein the hydrocarbon gas is brought into physical contact with the solid-state heat accumulator elements thereof during its passage through the heat accumulator reactor in order to accelerate the cracking. In addition, preferably a receiver reactor 1, 30, 40 is created in which the stratified heat accumulator reactor 172 is connected to a second line arrangement, which itself is connected to a hydrocarbon gas source, and which opens into the inner flow channel 176 for the products of the receiver reactor 1, 30, 40. Finally, a use is created for a stratified heat accumulator with solid-state heat accumulator elements, which are arranged in the inner flow channel thereof in such a way that during operation a heat transferring gas passes over and around them, with physical contact, as a heat accumulator reactor for cracking of a hydrocarbon gas, in particular methane.

As was noted previously, during cracking carbon may be deposited on the reaction accelerator (in the heat accumulator reactor 172: the solid-state heat accumulator elements and bulk material filling ad the ceramic blocks 177), and can be removed again by an oxidising gas such as steam. Correspondingly, a third line arrangement with a line 200 is additionally provided, which is connected to a source of oxidising gas and can supply the heat accumulator reactor 172 with steam, for example. In order to remove the carbon, the shut-off valves 170, 187 are closed correspondingly, and the shut-off valve 201 in the line 200 is opened. The hydrogen which collects again is discharged together with the carbon monoxide via the line 173.

A process is created in which an oxidising gas such as steam is fed preferably to the heat accumulator reactor 172 via a third line arrangement from a source and then passed through it in such manner that carbon which has been deposited on solid-state heat accumulator elements 177 is removed therefrom. Then, the stratified heat accumulator reactor 172 is connected to a third line arrangement for steam, wherein this line arrangement discharges into the inner flow channel 176 for the products of the receiver reactor 1, 30, 40.

FIG. 13 shows the arrangement of FIGS. 12a and 12b, but in this case with the addition of a heat accumulator reactor 172′, wherein this reactor is connected to the receiver reactor 1, 30, 40 via a line 171′ of the first line arrangement and to the discharge line 173 via a line 173′. A line 186′ with a shut-off valve 187′ connects the heat accumulator reactor 172′ to a hydrocarbon gas source, as is the case with the heat accumulator reactor 172, via the line 186. In other words, the heat accumulator reactor 172′ is preferably of the same construction type as the heat accumulator reactor 172, including all feed and discharge lines, wherein steam lines of a third line arrangement with the corresponding shut-off valves have been omitted in order to minimise the detail in the figure.

This configuration allows various circuits during operation of the receiver reactor 1, 30, 40, the heat accumulator reactor 172 and the heat accumulator reactor 172′. As one example thereof, FIG. 13 illustrates a circuit in which the heat accumulator reactor 172 is discharged by cracking of hydrocarbon that is supplied via the line 186 and the heat accumulator reactor 172′ is charged by the receiver reactor 1, 30, 40. For example, in this way it is possible for one heat accumulator reactor 172, 172′ to be charged at all times, while the other is being discharged by cracking or carbon residues from the cracking cycle are being eliminated therefrom in a steam cycle. According to the invention, it is also possible to interconnect more than two heat accumulator reactors in the manner shown and then run them in day- and night-time operation in a number of different circuits.

A process is preferably created in which multiple heat accumulator reactors 172, 172′ are connected to a receiver reactor (1, 30, 40) via a line arrangement, and each of the heat accumulator reactors is charged sequentially, discharged by cracking or freed from carbon deposits by a cycle with an oxidising gas such as steam. In this context, one heat accumulator reactor 172, 172′ is preferably connected to a third line arrangement which is in turn connected to a source of an oxidising gas such as steam, which opens into the inner flow channel for the products of the receiver reactor.

1. Process for cracking of hydrocarbon gases, wherein the hydrocarbon gas is passed through a flow channel of an absorptive receiver reactor, characterized in that cracking takes place while passing through the receiver reactor wherein in a first region of the flow channel the hydrocarbon gas is heated to its cracking temperature, in an adjoining second, downstream flow region it is heated to beyond its cracking temperature and in a third further downstream region of the flow channel it is heated yet further and is brought therein into physical contact over the cross-section of said region with a reaction accelerator, after which the stream of products is discharged from the receiver reactor downstream of the reaction accelerator, and wherein the heating of the hydrocarbon gas to above its cracking temperature is achieved by absorption of blackbody radiation, which is given off by the reaction accelerator heated by solar radiation incident thereon to the hydrocarbon gas flowing towards it, in such a way that the hydrocarbon gas in the flow channel and extending as far as the reaction accelerator forms disc-shaped temperature zones staggered one behind the other each at a higher temperature extending transversely to the flow channel.

2. Process according to claim 1, wherein an absorber of the receiver reactor is used as the reaction accelerator and medium that has passed through the receiver reactor flows through said reaction accelerator.

3. Process according to claim 1, wherein in the third flow region a cloud of particles is sprayed into the flowing hydrocarbon gas in such manner that cracking is initiated over the cross-section of the flow, and wherein the cloud is formed in such manner that it lies in the path of the incident sunlight, absorbs it the incident sunlight and is warmed thereby and gives off blackbody radiation into the flowing methane upstream as well.

4. Process according to claim 3, wherein soot particles are used as particles.

5. Process according to claim 1, wherein a reducible gas is passed through the receiver reactor cyclically instead of a hydrocarbon gas in a hydrocarbon gas cycle, in such manner that soot deposited in the flow channel is dissolved during an oxidation cycle by chemical reaction with the reducible gas.

6. Process according to claim 5, wherein steam is used as the reducible gas, preferably in such manner that the receiver reactor produces syngas in the oxidation cycle and carbon black and hydrogen in the hydrocarbon gas cycle.

7. Process according to claim 1, wherein an absorber or parts of the absorber are replaced or cleaned during continuing operation after a predetermined threshold of deposits is reached.

8. Process according to claim 1, wherein the hydrocarbon gas is methane.

9. Process according to claim 1, wherein at least the hydrocarbon gas is supplied tangentially to a longitudinal axis of the flow channel, in such manner that the gas directed towards the third region of the flow channel also rotates about an axis parallel to the longitudinal axis.

10. Process according to claim 1, wherein at least one of the gases is hydrocarbon gas or the reducible gas in at least the regions and of the regions to of the flow channel is caused to rotate, in such manner that it has a develops a twist about an axis parallel to the direction of transport in the flow channel.

11. Process according to claim 1, wherein in the hydrocarbon gas cycle CO₂ is fed to the receiver reactor in addition to the hydrocarbon gas and is passed through said receiver reactor, in such manner that it is heated absorptively together with the hydrocarbon gas.

12. Process according to claim 11, wherein methane is used as the hydrocarbon gas and in the third region of the flow channel the number of moles of methane to the number of moles in the mixture of methane and CO₂ is 60 to 90%, preferably, 60-70%, particularly preferably 66.67%.

13. Process according to claim 11, wherein a warm stream of products discharged from the receiver reactor downstream from the reaction accelerator, is supplied via a first line arrangement to a stratified heat accumulator reactor with solid-state heat accumulator elements and is then passed through these, in such manner that it is charged with heat emanating from the products up to a temperature above the cracking temperature.

14. Process according to claim 13, wherein a heat accumulator reactor charged with heat is discharged by the process of cracking hydrocarbon gas therein.

15. Process according to claim 14, wherein hydrocarbon gas is fed to the heat accumulator reactor via a second line arrangement from a hydrocarbon gas source, and is then passed through said reactor, wherein the hydrocarbon gas is brought into physical contact with the solid-state heat accumulator elements while it is passing through the heat accumulator reactor in order to accelerate the cracking.

16. Process according to claim 14, wherein oxidising gas is fed to the heat accumulator reactor via a third line arrangement from a source for an oxidising gas and is then passed through said reactor in such manner that carbon deposited on the solid-state heat accumulator elements is removed therefrom, wherein preferably the oxidising gas is steam, CO₂ or a mixture of these gases.

17. Process according to claim 14, wherein multiple heat accumulator reactors are connected to a receiver reactor via a first line arrangement and connected to a hydrocarbon gas source via a second line arrangement and one of the heat accumulator reactors is charged alternatingly, while another is discharged by the cracking of hydrocarbon gases.

18. Receiver reactor for cracking a hydrocarbon gas, in particular methane, which includes an aperture for the radiation of the sun, and a flow channel for passing methane that is to be cracked through the receiver reactor, and an absorber region which is arranged in the path of the incident solar radiation, and is designed for absorption thereof, which emits blackbody radiation upstream into the flow channel during operation, characterized in that the absorber region is arranged and designed in such manner that it is located opposite the aperture for the radiation of the sun and during operation is illuminated over its entire expanse by solar radiation incident directly thereon, wherein supply line sections are provides for a hydrocarbon gas and supply line sections are provided for a carbon oxidising gas, which are switchable in such manner that the receiver reactor can be operated alternatingly with the hydrocarbon gas and with the reducible gas.

19. Receiver reactor according to claim 18, wherein two line arrangements are provided which discharge into the flow channel independently of each other.

20. Receiver reactor according to claim 18, wherein the reducible gas is steam.

21. Receiver reactor for cracking a hydrocarbon gas, in particular methane, which has an aperture for the radiation of the sun and a flow channel for passing methane that is to be cracked through the receiver reactor; and an absorber region which is arranged in the path of the incident solar radiation, and is designed for absorption thereof, which emits blackbody radiation upstream into the flow channel during operation, characterized in that the absorber region is arranged and constructed in such manner that it is located opposite the aperture for the radiation of the sun and during operation is illuminated over its entire expanse by solar radiation incident directly thereon, wherein further the absorber region includes an apparatus for generating a cloud of particles.

22. Receiver reactor according to claim 21, wherein the apparatus has at least one spray nozzle for particles, preferably soot particles, for the purpose of generating particles.

23. Receiver reactor for cracking a hydrocarbon gas, in particular methane, which has an aperture for the radiation of the sun and a flow channel for passing methane that is to be cracked through the receiver reactor, and an absorber region which is arranged in the path of the incident solar radiation, and is designed for absorption thereof, which emits blackbody radiation upstream into the flow channel during operation, characterized in that the absorber region is arranged and constructed in such manner that it is located opposite the aperture for the radiation of the sun and during operation is illuminated over its entire expanse by solar radiation incident directly thereon, and that it is designed to allow the hydrocarbon gas passing through the flow path to flow through it, wherein further an absorber is provided in the absorber region, which absorber includes absorber elements which are movable independently of each other between an operating position in the absorber region and a replacement position outside the absorber region absorber elements and a movement apparatus for the absorber elements.

24. Receiver reactor according to claim 23, wherein the movement apparatus is designed to change a current operating situation of the absorber elements in their operating position in predetermined manner.

25. Receiver reactor according to claim 23, wherein in the idle position the movement apparatus is designed to replace used absorber elements with fresh absorber elements.

26. Receiver reactor according to claim 18, wherein the feed channels are constructed tangentially to a longitudinal axis of the flow channel, in such manner that during operation of the receiver reactor the process gas in the flow channel has a twist about this axis on its path to the absorber region.

27. Receiver according to claim 18, wherein the side walls of the flow channel and/or the absorber region are free from cooling means, in particular cooling channels, for the operation of the receiver in accordance with its intended use.

28. Receiver reactor according to claim 18, wherein the transport apparatus has apertures for the hydrocarbon gas which lead into the absorber chamber, which are arranged adjacent to a wall of the absorption chamber, and which create a flow component in the primary flow direction of the fluid flowing into the absorption chamber with an inclination relative to the wall of less than 15 degrees, preferably equal to or less than 10 degrees, particularly preferably equal to or less than 5 degrees.

29. Receiver reactor according to claim 18, wherein the transport apparatus has apertures for the hydrocarbon gas which lead into the absorber chamber, which create a flow component of the fluid flowing into the absorption chamber which is tangential to an axis of the absorption chamber.

30. Receiver reactor according to claim 18, wherein further supply line sections are provided for CO₂ which are switchable in such manner that a mixture of the hydrocarbon gas, particularly methane, and CO₂ can be fed to the flow path of the receiver reactor.

31. Receiver reactor according to claim 18, wherein the outlet thereof is connected to a stratified heat accumulator reactor via a first line arrangement, which has an inner flow path for transporting the products of the receiver reactor, in which in turn solid-state heat accumulator elements are arranged in such manner that the products transported through flow around and/or through them, coming into physical contact.

32. Receiver reactor according to claim 31, wherein the stratified heat accumulator reactor is connected to a second line arrangement which in turn is connected to a hydrocarbon gas source, which discharges into the inner flow path for the products of the receiver reactor.

33. Receiver reactor according to claim 31, wherein the stratified heat accumulator reactor is connected to a third line arrangement which in turn is connect to a source for an oxidising gas, in particular steam or CO₂, or a mixture thereof, which discharges into the inner flow path for the products of the receiver reactor.

34. Use of a stratified heat accumulator with solid-state heat accumulator elements, which are arranged in the inner flow path thereof in such manner that during operation a gas flows around them, with physical contact, as a heat accumulator reactor for cracking a hydrocarbon gas, in particular methane.
